(19) United States
(12) Patent Application Publication
(10) Pub. No.: US 2008/0082961 A1
(43) Pub. Date: Apr. 3, 2008

(54) EXTENSIBILITY MECHANISMS FOR VISUAL PROGRAMMING

(76) Inventors: Gregory D. Adams, Dunrobin (CA); P. Randolph Giffen, Kemptville (CA); Kevin T. McGuire, Ottawa (CA); Karice L. McIntyre, Nepean (CA); Raymond Tsui, Ottawa (CA)

Correspondence Address: MARCIA L. DOUBET LAW FIRM, PO BOX 422859, KISSIMMEE, FL, 34742, US

(21) Appl. No.: 11/536,303

(22) Filed: Sep. 28, 2006

(51) Int. Cl. G06F 9/44; G06F 3/00

(52) U.S. Cl. 717/109; 717/113; 715/700

(57) ABSTRACT

In certain aspects, the invention is directed to a method for visual programming in an environment having a set of user-invocable function representations, a data processing system for implementing the method and a computer program product with computer-usable program code for implementing the method. The method includes:
maintaining a user interface from which a user may access any function representation in the set of user-invocable function representations;
receiving a new function representation that is omitted from the set of user-invocable function representations; and
storing the new function representation in the set of user-invocable function representations so that the new function representation may be accessed from the user interface.

### RESERVATION OF COPYRIGHT

A portion of the disclosure of this patent document contains material to which a claim of copyright is made. The copyright owner has no objection to the facsimile reproduction by anyone of the patent document or the patent disclosure, as it appears in the Patent and Trademark Office patent file or records, but reserves all other rights whatsoever.

### BACKGROUND OF THE INVENTION

The invention relates to the field of visual programming and more particularly to mechanisms for extending the functionality of a visual editor.

A visual programming environment (also referred to as a graphical programming environment) permits a user to author a computer program by manipulating graphical elements instead of writing text. Such environments may be easier for some users to use, particularly if the user is unfamiliar with the syntax of a textual programming language, or if the user is only an occasional user of a textual programming language. Users may include both non-programmers and programmers. Visual programming environments may include a set of functions which are callable when the user is preparing a visual program block. The set of functions, however, can in some instances be limited, relative to the needs of the user.

### BRIEF SUMMARY OF THE INVENTION

In one aspect, the invention is directed to a method of visual programming in an environment having a set of user-invocable function representations, including: maintaining a user interface from which a user may access any function representation in the set of user-invocable function representations; receiving a new function representation that is omitted from the set of user-invocable function representations; and storing the new function representation in the set of user-invocable function representations so that the new function representation may be accessed from the user interface.

In another aspect, the invention is directed to a data processing system for implementing the method described above.

In another aspect, the invention is directed to a computer program product with computer-usable program code for implementing the method described above.

### BRIEF DESCRIPTION OF THE SEVERAL VIEWS OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a pictorial representation of a data processing system in which aspects of the present invention may be implemented;

FIG. 2 is a block diagram of a data processing system in which aspects of the present invention may be implemented;

FIG. 3 is a layout of an exemplary visual editor in accordance with an embodiment of aspects of the present invention;

FIG. 4 is a diagram of a function that may be defined using the visual editor shown in FIG. 3;

FIG. 5 is a view of an exemplary list of function representations that may be provided for use when using the visual editor shown in FIG. 3;

FIG. 6 is a code listing of a function defined declaratively that may be added to the function representations available for use when using the visual editor shown in FIG. 3;

FIG. 7a is another code listing of a function representation defined declaratively;

FIG. 7b is a declarative code listing after having run a configurer which permits additional narrowing of definition;

FIG. 8a is a dialogue permitting entry of information including the identity for a function representation named “UpperCaseFirstLetter” to be added to the set of function representations available for use when using the visual editor shown in FIG. 3;

FIG. 8b is a dialogue permitting entry of information relating to input data and output data regarding the function representation named “UpperCaseFirstLetter”;

FIG. 8c is a layout showing the graphical function representation named “UpperCaseFirstLetter”;

FIG. 9a is a view of a dialogue for calling a visual representation of a primitive function that exists in a library of a programming language from a visual editor in accordance with an aspect of an embodiment of the present invention;

FIG. 9b is a code listing of a primitive function definition;

FIG. 9c is a view of the dialogue shown in FIG. 9a, showing the primitive function definition described in FIG. 9b;

FIG. 10 is a view of a dialogue for calling a primitive function that exists in a library of a programming language from a visual editor in accordance with an aspect of an embodiment of the present invention; and

FIG. 11 is a flow diagram illustrating a method in accordance with an embodiment of the present invention.

### DETAILED DESCRIPTION OF THE INVENTION

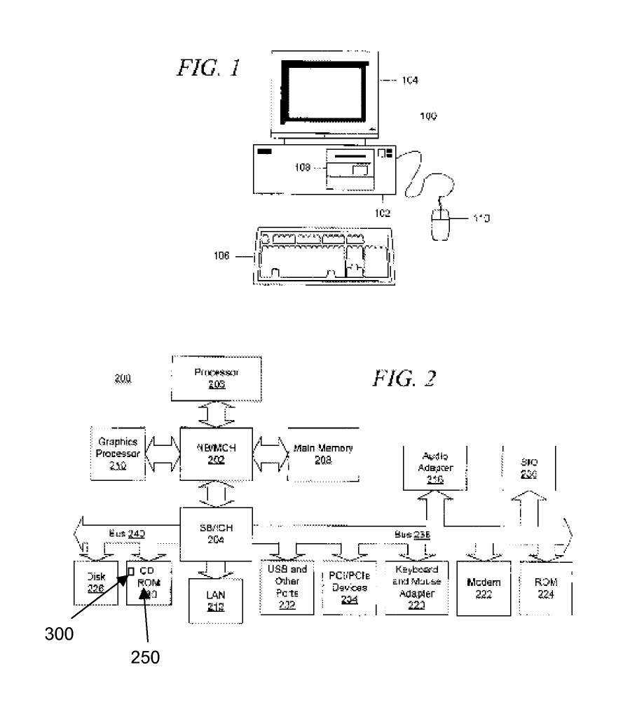

FIG. 1 is a pictorial representation of a data processing system in which aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 may be implemented using any suitable computer, such as an IBM® eServer™ computer or IntelliStation® computer, which are products of International Business Machines Corporation, located in Armonk, N.Y. Although the depicted representation shows a personal computer, exemplary aspects of the present invention may be implemented in other types of data processing systems, such as laptop computers, palmtop computers, handheld computers, network computers, servers, workstations, cellular telephones and similar wireless devices, personal digital assistants and other electronic devices on which software programs may be installed. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as personal computer 100 in FIG. 1, in which code or instructions implementing the processes of the exemplary aspects may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH 202 through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 424, universal serial bus (USB) ports and other communications ports 232, and PCI/PCIe devices 234 connect to south bridge and I/O controller hub 204 through bus 238. Hard disk drive (HDD) 226 and CD-ROM drive 230 connect to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. Aspects of the present invention may be performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which may be configured with flash memory to provide non-volatile memory for storing operating system files and/or user-generated data. A memory may be, for example, main memory 208 or a cache such as found in north bridge and memory controller hub 202. A processing unit may include one or more processors. The depicted examples in FIGS. 1-2 and above-described examples are not meant to imply architectural limitations. For example, data processing system 200 also may be a tablet computer, laptop computer, or telephone device in addition to taking the form of a PDA.

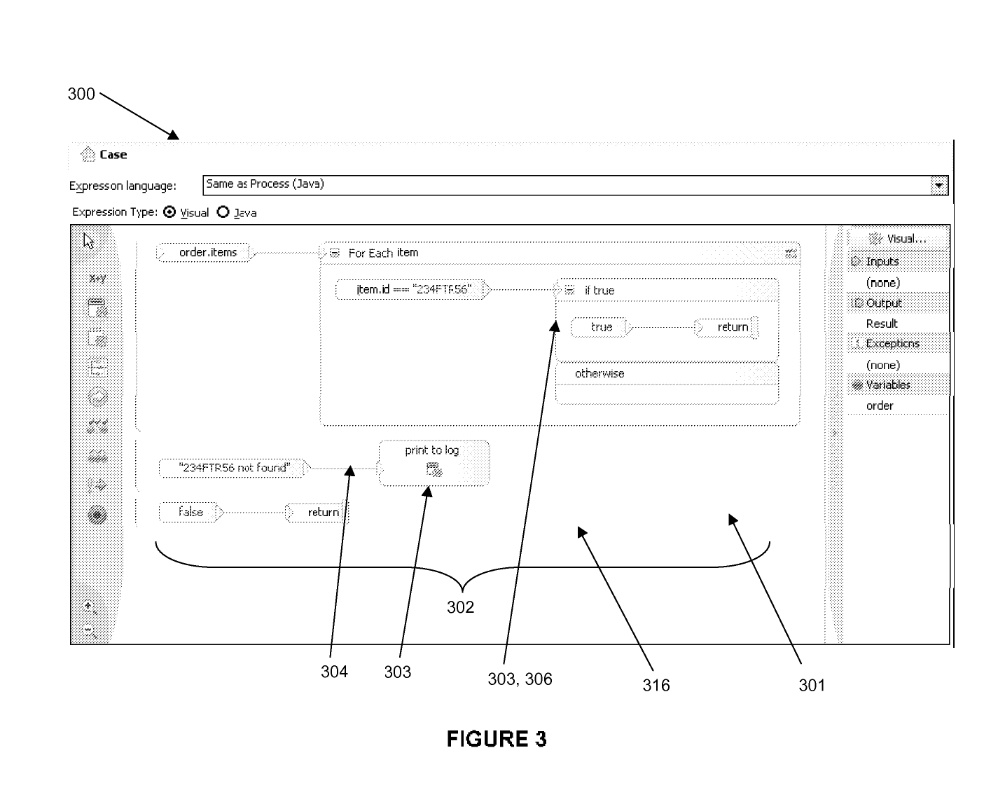

Reference is made to FIG. 3, which shows an exemplary visual editor 300 in accordance with an aspect of an embodiment of the present invention. The visual editor 300 is a user interface that permits a user to create and edit a graphical representation of computer program code in a work area 301. The graphical representation may be referred to as a graphical code representation 302.

The graphical code representation 302 may represent a portion of a computer program, or alternatively may represent a complete computer program. The graphical code representation 302 may be translated into program code by any suitable means. For example, the translation may be performed by one or more programmers, or may alternatively be performed by translation software, or may alternatively be performed by some combination of the two. The resulting translated product may be in any suitable form. For example, the translated product may be source code in a programming language. Alternatively, for example, the translated produce may be in the form of machine code.

The graphical code representation 302 may be in the form of blocks 303, which may also be referred to as nodes 303, and data flow lines 304. The nodes 303 are graphical representations of an activity that a user wishes to occur. For example, in the exemplary graphical code representation 302, the node shown at 306 represents the determination of whether or not the value of the variable “item.id” is equal to “234FTR56”.

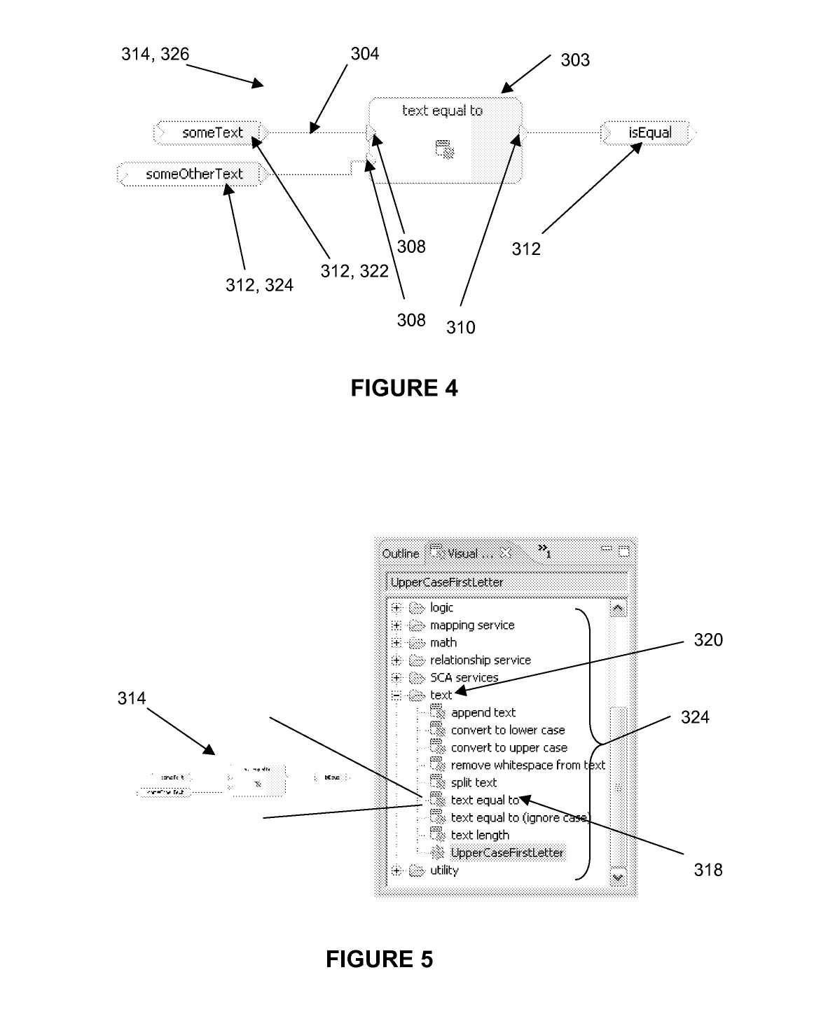

Referring to FIG. 4, a node 303 may have one or more input terminals 308 thereon, which indicates that the activity represented by the node 303 requires one or more input data items. The term “input data item” is meant to be interpreted broadly and can mean numeric values, textual data, logical values, graphical data or any other suitable type of input data. The node 303 could alternatively have no input terminals 308 thereon, indicating that no input data is required by the activity represented by the node 303.

The node 303 may have one or more output terminals 310 thereon, which indicates that the activity represented by the node 303 produces one or more items of output data. The term “output data” is meant to be interpreted broadly and can mean numeric values, textual data, logical values, graphical data or any other suitable type of output. The node 303 could alternatively have no output terminals 310 thereon, indicating that the activity represented by the node 303 produces no output data.

It will be understood that the number and type of input terminals 308 and output terminals 310 are not necessarily related to each other. For example, a node 303 may have one or more input terminals 308 and no output terminals 310, or one or more input terminals 308 and one or more output terminals 310. Similarly a node 303 may have no input terminals 308 and no output terminals 310 or no input terminals 308 and one or more output terminals 310.

Data flow lines 304 connect to and from input and output terminals 308 and 310 respectively and graphically represent the data flow to and from the activities represented by the nodes 303. The data flow lines 304 may appear as simple lines to and from nodes 303. In some instances, including all those shown in FIG. 4, a variable name box 312 will appear along a data flow line 304, which indicates the name of the variable that holds the data that is inputted to or outputted from a node 303.

The visual editor 300 may be used to combine nodes 303 and data flow lines 304 to form graphical representations of functions, which may be referred to as graphical function representations 314 (see FIG. 4). The term “function” is used to describe any unit of functionality and is not intended to be limited to any specific type of program component. For example, a function as defined within the context of this disclosure and the appended claims may be a routine that requires some or no input data and may provide some or no output data. From the viewpoint of program flow control, a function, after completing its task, may return program flow control to the location in the code from which the function was called. Alternatively, the function may send program flow control to some other point in the code. A function may be an entire program or may be a portion of a program. A function may itself be made up of one or more other functions.

Referring to FIG. 4, an exemplary graphical function representation 314 is shown. The exemplary graphical function representation 314 represents a function which compares two strings of text, which are stored in variables “someText” and “someOtherText”, to determine if they are equal. The function represented by function representation 314 outputs the result of the comparison to the variable “IsEqual”.

The graphical function representation 314 has a name 318 and optionally has a category 320 associated therewith. In the exemplary graphical function representation 314 (FIG. 5), the name is “text equal to” and the category is “text”.

As noted above, the function represented by a graphical function representation 314 may have zero, one or more input data items associated therewith and may have zero, one or more output data items associated therewith. The function represented by the exemplary graphical function representation 314 shown in FIG. 4 has associated therewith two input data items, which are stored in the variables named “someText” and “someOtherText” and which are represented by the variable name boxes shown at 322 and 324.

The function represented by the graphical function representation 314 may have one or more exceptions associated therewith which control the conditions under which the function would operate. No exceptions are shown, however, for the exemplary graphical function representation 314 shown in FIG. 4.

The function represented by the graphical function representation 314 has an implementation, which is the computer code (not shown) defining the tasks that are to be accomplished by the function.

The function represented by the graphical function representation 314 may optionally have a description associated therewith. No description is shown, however, for the function represented by the exemplary graphical function representation 314 shown in FIG. 4.

Referring to FIG. 5, the visual editor 300 may include a set 324 of graphical function representations 314, which are organized by name and category. The user may bring into the work area 301 any of these graphical function representations 314 to represent desired functions. In some instances, however, the user will want to access a function that is not already represented in the set 324. Using the visual editor 300, the user can define a representation 326 of a new function, and can store the representation 326 in the set 324 of graphical function representations 314 for optional use in the future. One skilled in the art will, once informed by the disclosure herein, be able to provide for storage of the representation 326 in the set 324 so as to make the representation 326 accessible from the user interface, by any suitable means. Thus, once it has been stored as part of the library of available function representations 326, the new function representation 326 can be accessed the same way as any pre-existing graphical function representation 314 would be accessed from the set 324. It will be appreciated that the function representation 326 need not be stored in the same folder as the pre-existing graphical function representations 324.

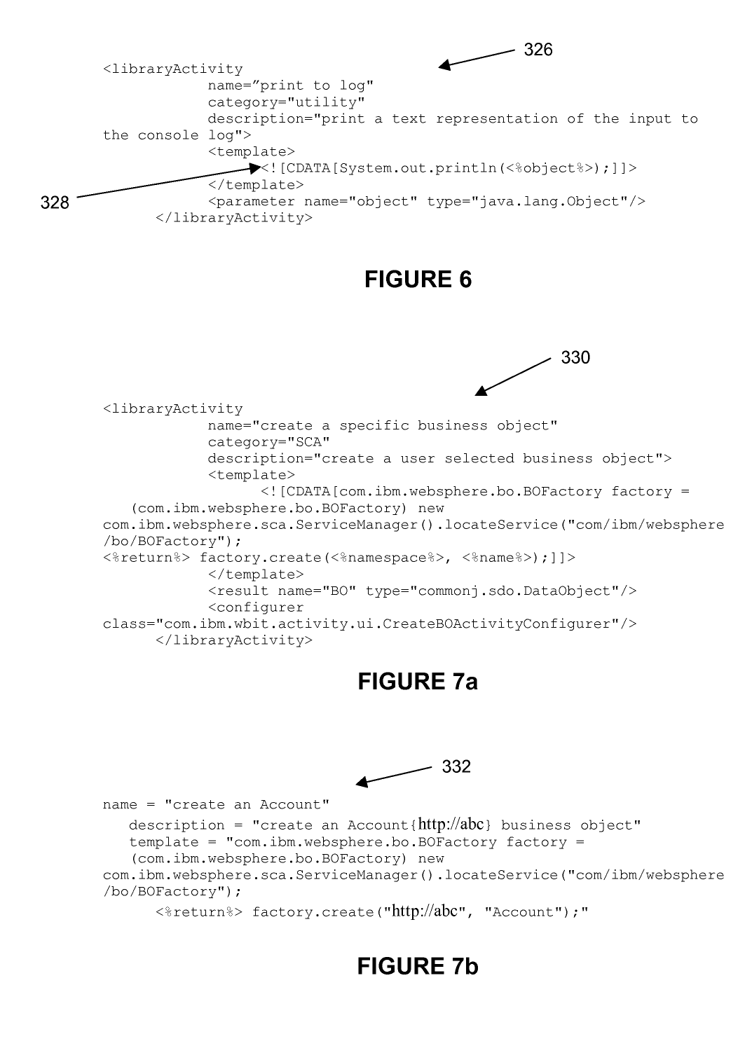

The visual editor 300 may be configured to permit the user to define a new function representation, such as the new function representation 326, in one or more ways. For example, the visual editor 300 may be configured to permit the user to define a new function representation declaratively. This means that the user may define the new function representation using a declarative textual format instead of a graphical format. A declarative representation of a function is a textual representation of what the user wishes the function to accomplish. It is thus similar to a graphical function representation in the sense that the user focuses on what the function accomplishes without focusing on how the function accomplishes it (i.e. without writing any source code). For example, the declarative function representation shown in FIG. 6 provides a function name, which is “print to log”, a category, which is “utility” and a description, which is “print a text representation of the input to the console log”. The represented function has associated input data, which is stored in a variable called “object” and which is of the type “java.lang.Object”. The operation of the function is described in the text following the term “CDATA”, shown at 328. It does not specify how the text representation of the input is printed to the console log.

The function representation shown in FIG. 6 may be referred to as a template, in the sense that it is not itself executable as a function, but it is importable or translatable into code which, coupled with the input data from the variable “object”, may then be executable as a function.

In cases where the code returns program control to the location from which the function was called, a special identifier may be used which can be replaced at runtime by code that would cause a return.

Reference is now made to FIG. 7a. In some instances, a higher-level template may be used to represent a function. An example of such a template is shown at 330. In the template 330, a configurer is invoked, which obtains, from the user, data which is to be stored in the variables “namespace” and “name”. The configurer then uses the data stored in these variables to convert the high-level template into a more narrowly defined declarative function representation, an example of which is shown at 332 in FIG. 7b. The more narrow declarative function representation 332 is directed to specifically creating an account instead of creating a ‘business object’. The configurer itself is not shown in the Figures.

It will be understood that the declarative function representation is not source code or machine code. It is still a representation of code. At some point, some translation means is required to translate the declarative function representation into source code or machine code.

It will be further understood that the function representations 326, 330 and 332 in FIG. 6 and FIGS. 7a and 7b respectively are defined using simple text which can be modified at any time, without the need for compiling or repackaging since they are not themselves program code.

The function representations 326, 330 and 332 may be copied directly into the work area 301 (FIG. 3) where they are later used to generate code. This is advantageous because if the user creates a custom declarative function representation and adds it to his/her personal library, he/she can copy the function representation into the graphical code representation and send that to a second user who might not have had the custom function representation in his/her library. In this way, the second user is not required to already have all the same function representations in his/her library as the first user in order to be able to work with the graphical code representation sent by the first user.

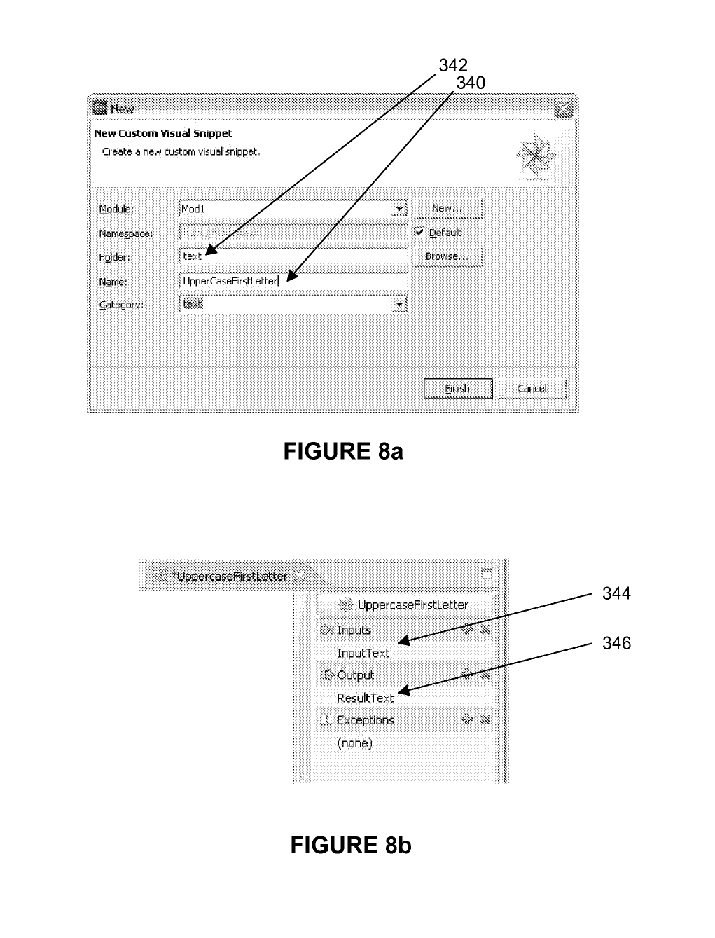

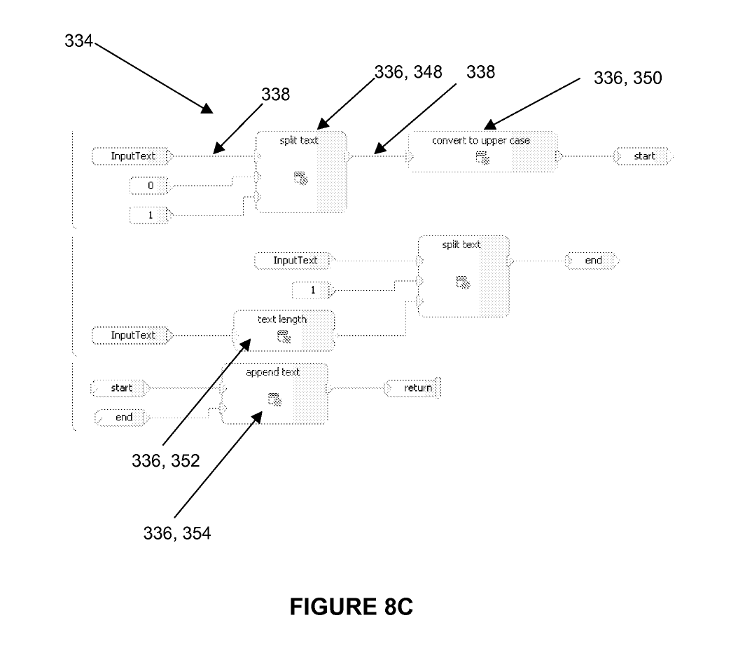

Instead of defining a new function representation declaratively, the new function representation may be defined visually, for example by using the visual program editor 300 itself. An exemplary visual or graphical function representation is shown at 334 in FIG. 8c.

As shown in FIG. 8c, the user may define the new function representation 334 visually using nodes 336 and data flow lines 338. The graphical function representation 334 may be provided with a name and category (shown at 340 and 342 respectively in FIG. 8a) using an interface as shown in that figure, or using any other suitable interface. The user may define any input data and output data, shown at 344 and 346 respectively in FIG. 8b, optionally using an interface as shown in that figure, or using any other suitable interface.

The new function representation 334 may be defined using whatever elements are available in the function representation set 324 (FIG. 5). For the exemplary function representation 334 shown in FIG. 8c, the overall purpose is to replace the first letter in a string of text with the uppercase form of that letter. As can be seen in FIG. 8c, the user has called several existing function representations, such as “split text” shown at 348, “convert to upper case” shown at 350, “text length” shown at 352 and “append text” shown at 354 in the definition of the new function representation 334, and it is seen that the value assigned to the variable “start” generated by the function “convert to upper case” 350 is later used as input for the function “append text” 354. Each of function “convert to upper case” 350 and “append text” 354 form part of overall new function representation 334.

The definition of the function 334 may be defined using the same visual editor 300 shown in FIG. 3 that is used for creating graphical code representation 302. Alternatively a variant of the visual editor 300 may be used.

Once completed, the new function 334 may be saved anywhere, such as, for example, in the same folders as the set 324 (FIG. 5) and may be called by the user at any time afterwards when creating a graphical code representation. One skilled in the art will, once informed by the disclosure herein, be able to provide for storage of the function 334 in the set 324 so as to make the function 334 accessible from the user interface, by any suitable means.

An advantage of providing the capability of adding a function representation using the visual language itself is that the user is not required to learn a new language and new language syntax. They can define the function using the same system, e.g. the visual editor 300 (FIG. 3), which is used to create the graphical code representation 302.

The visual editor 300 may be configured to permit a user to convert some portion of a graphical code representation 302 into a graphical function representation 334 for storage and later use as one of the usable function set 324 (FIG. 5).

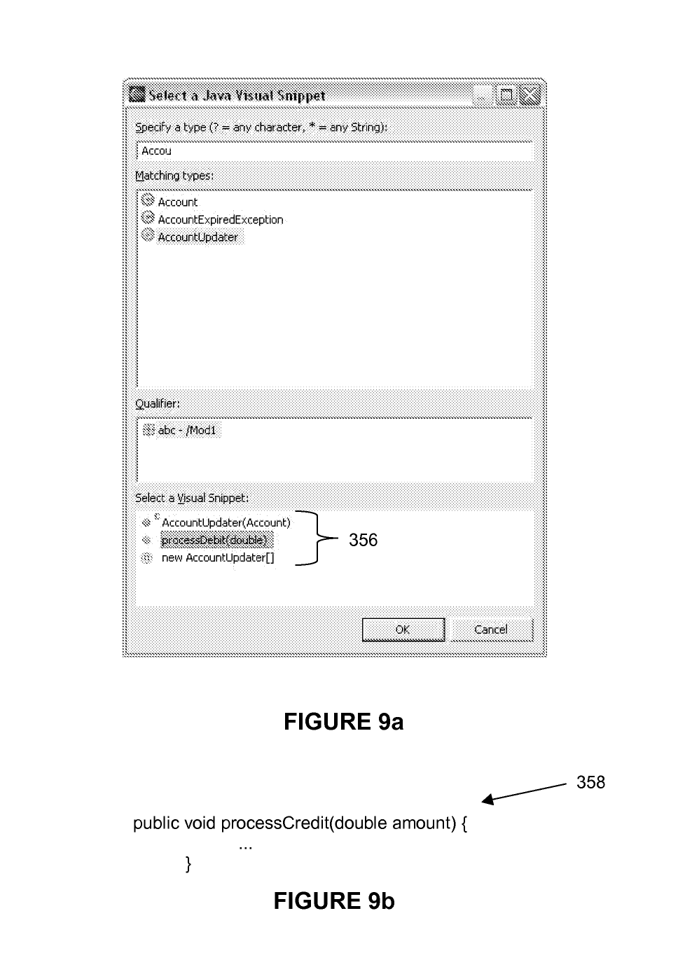

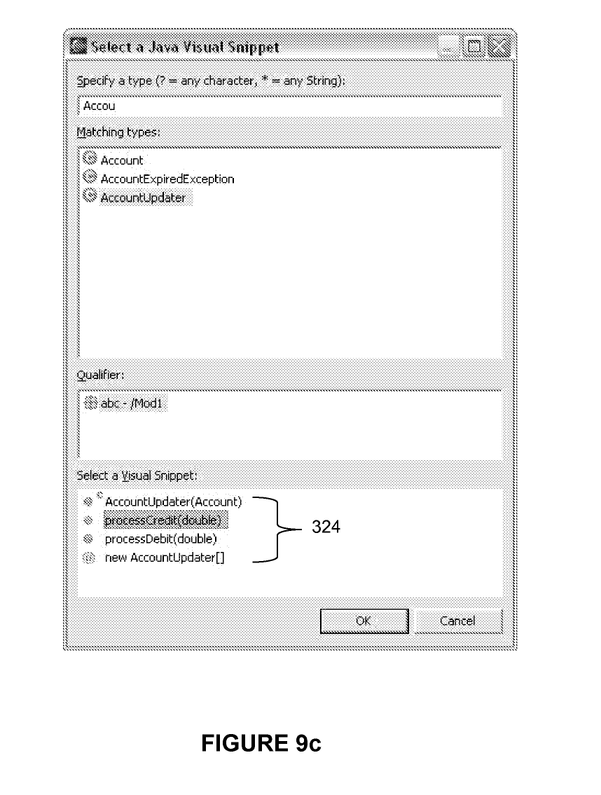

Reference is made to FIGS. 9a, 9b and 9c, which illustrate another way of creating a function representation that may be stored and used as part of the function set 324 (FIG. 9c). In some cases, the computer language into which the graphical code representation 302 will be translated will contain its own set or library of available functions. These functions may be referred to as ‘primitive’ functions. These primitive functions may be made available through the visual editor 300. This permits the user to represent relatively low-level functions where such functions are not easily represented by what in some embodiments might be relatively high-level representation capabilities of the visual editor 300 itself. This can be of assistance in situations where the user needs to define relatively specific and detailed behaviour.

When searching through a list of available primitive functions (shown at 356 in FIG. 9a), the user may find that no primitive function 356 fulfills his/her needs. Thus, the user may create his/her own new primitive function 358 (see FIG. 9b) using a suitable editor. Note that the visual editor 300 (FIG. 3) may itself have the capability to provide suitable text editing capability for such a purpose. Alternatively, the user may create the primitive function 358 in some other editor (not shown).

The user may then save the new primitive function 358 in the same folder as the existing primitive functions 356. When the user wishes to view all the primitive functions in that folder, the new function 358 can be made to appear in the list by dynamically creating the list of primitive functions available (FIG. 9c). This assists the user in selecting appropriate function calls, particularly when the user may not be thoroughly familiar with the programming language in which the visual program block 301 will be translated.

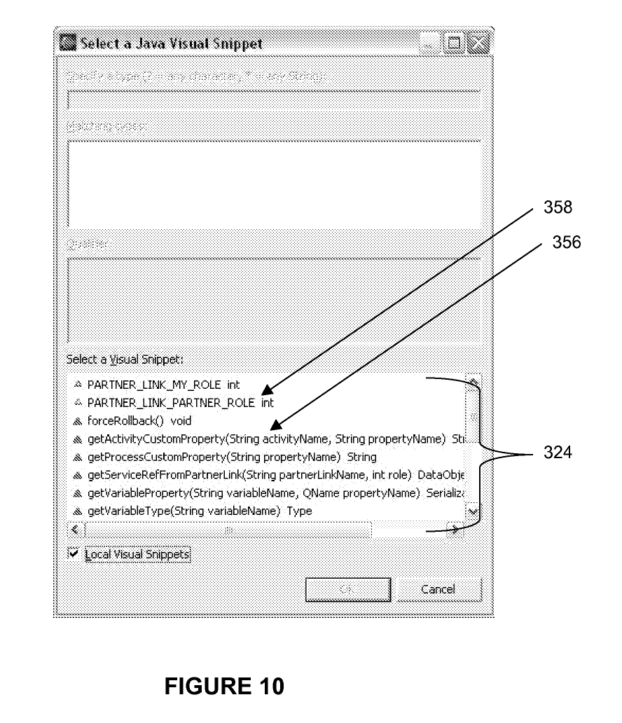

A variant of the mechanism permitting the use of primitive functions permits the primitive function 358 to be added to the set 324 of graphical function representations 326 as a graphical function representation 326. This permits calls to primitive functions 356 which may not exist on the computer or network in which the visual editor 300 is being used, but which will exist on the computer or server where the executable file will ultimately reside when the code is executed. Such function representation calls may be referred to as local visual snippets (see FIG. 10).

Another variant of the mechanism for adding primitive function calls is to define the new function visually, wherein the definition is simply a primitive function call. The details of the implementation of the primitive function may be kept hidden in the primitive function since the user can define the necessary information (e.g. input data, output data), using the visual editor 300 without having to become educated on the nuances of working directly with primitive contacts. The new function representation 314 would appear in the set 324 and can be added to a graphical code representation 302 as could any other graphical function representation 314.

Calling the primitive function from the visual editor 300, and saving it among the set 324 of graphical function representations 314, facilitates access by the user, since the user does not have to look up the function in a potentially less clear list of primitive functions in a primitive function lookup. A user strategy could be to create visual calls to primitive functions for what the user considers to be commonly used or important primitive functions. It is alternatively possible for primitive functions to be added by using a declarative format, described above in relation to FIGS. 5 and 6.

Representations of local function calls permit clients of the visual editor 300 to define functions which are specifically appropriate for their use. Thus, such functions would not necessarily exist in a library of general function representations that would be distributed with the editor 300.

Permitting the use of primitive function calls to be added to the available functions permits a more experienced user to access new functions in the underlying programming language. If this is provided in combination with a mechanism for defining new function representations 326 visually as described above with respect to FIGS. 8a-8c, the visual editor 300 can be used advantageously by both experienced and inexperienced users, and to add functions 314 that are both high level and low level in nature.

The visual editor 300 may be stored as a set of instructions on any suitable type of computer usable medium, examples of which are shown at 226 and 230 in FIG. 2. The processor, shown at 206 in FIG. 2, is adapted to carry out the set of instructions by causing the data processing system 100 (FIG. 1) to provide a set of user-invocable graphical function representations, which may include, for example, the function set 324 (FIG. 5), maintain a user interface, such as, for example, the visual editor 300, from which a user may access any function representation in the set of user-invocable function representations, receive a new function representation that is omitted from the set of user-invocable function representations, and store the new function representation in the set of user-invocable function representations so that the new function representation may be accessed from the user interface.

The new function representation may be a first function representation and may be defined visually. The processor 206 (FIG. 2) may be adapted to carry out the set of instructions by causing the data processing system 100 (FIG. 1) to receive a second new function representation that is omitted from the set of user-invocable function representations, wherein the second new function representation is a call to a primitive function in an imperative programming language, and store the second new function representation in the set of user-invocable function representations.

In another aspect, a computer program product shown at 250 in FIG. 2 may be provided comprising at least one computer-usable medium including computer-usable program code for providing a visual programming environment. The computer program product includes computer-usable program code for a set of user-invocable function representations, computer-usable program code for receiving function definition input from a user, for defining a new function representation that is omitted from the set of user-invocable function representations, and computer-usable program code for storing the new function representation in the set of user-invocable function representations.

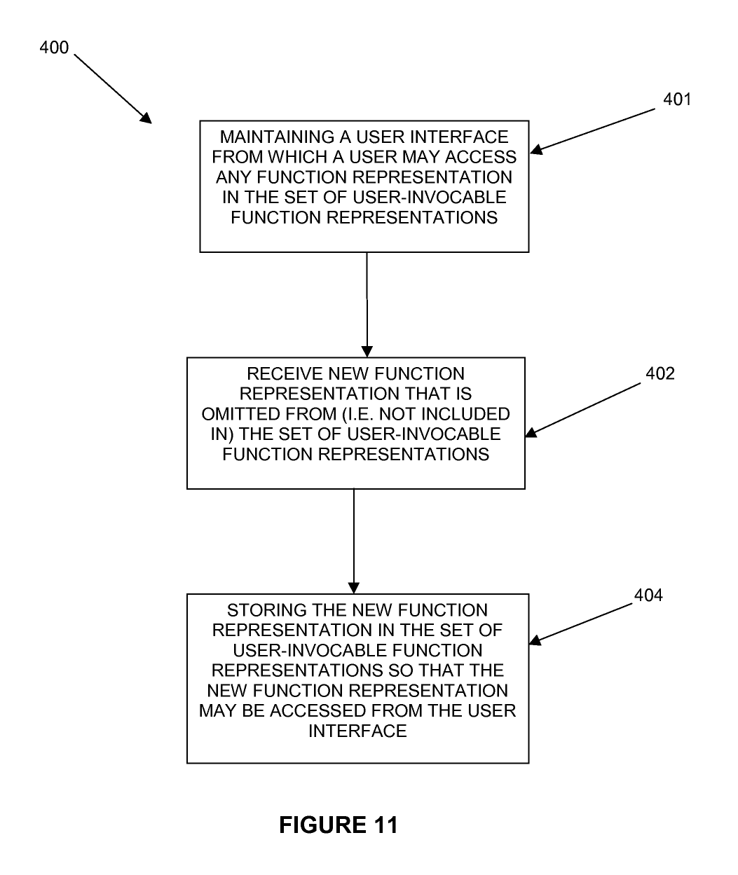

Reference is made to FIG. 11, which shows a flow chart of a method 400 of visual programming in an environment having a set of user-invocable function representations, in accordance with another embodiment of the present invention. Step 401 of the method 400 includes maintaining a user interface, such as the visual editor 300 (FIG. 3), from which a user may access any function representation in the set of user-invocable function representations. Step 402 of the method 400 includes receiving a new function representation that is omitted from the set of user-invocable function representations. Step 404 of the method 400 includes storing the new function representation in the set of user-invocable function representations so that the new function representation may be accessed from the user interface.

At step 402, the new function representation may be defined declaratively. Alternatively, the new function representation may be defined visually. The new function representation may be a call to a primitive function in an imperative programming language. In embodiments wherein the function is a call to a primitive function, the function may be defined visually, declaratively or otherwise.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product shown at 250 in FIG. 2, accessible from a computer-usable or computer-readable medium, examples of which are shown at 226 and 230 in FIG. 2, providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While the above description provides example embodiments, it will be appreciated that the present invention is susceptible to modification and change without departing from the fair meaning and scope of the accompanying claims. Accordingly, what has been described is merely illustrative of the application of embodiments of the invention. Numerous modifications and variations of the present invention are possible in light of the above teachings. It is therefore to be understood that within the scope of the appended claims, the invention may be practiced otherwise than as specifically described herein.

Copyright in this application and in any patent issuing herefrom, including without limitation copyright in all screen representations and partial screen representations, is retained by International Business Machines Corporation and/or its related companies. A limited license is granted to reproduce this application, or any patent to issue herefrom, solely in its entirety in the form in which it is published by a patent office in which it has been filed. No right or license is granted to reproduce any part of this application, or of any patent to issue herefrom, other than as a component of the entire document as published by a patent office in which it has been filed.

We claim:

1. A data processing system comprising:
at least one processor;
a bus coupled to the at least one processor;
at least one computer usable medium coupled to the bus, wherein the at least one computer usable medium contains a set of instructions and wherein the at least one processor is adapted to carry out the set of instructions by causing the data processing system to:
provide a set of user-invocable function representations;
maintain a user interface from which a user may access any function representation in the set of user-invocable function representations;
receive a new function representation that is omitted from the set of user-invocable function representations; and
store the new function representation in the set of user-invocable function representations so that the new function representation may be accessed from the user interface.

2. A data processing system as claimed in claim 1, wherein the new function representation is defined declaratively.

3. A data processing system as claimed in claim 1, wherein the new function representation is defined visually.

4. A data processing system as claimed in claim 1, wherein the new function representation is a call to a primitive function in an imperative programming language.

5. A data processing system as claimed in claim 4, wherein the new function representation is a first function representation, and wherein the at least one processor is further adapted to carry out the set of instructions by causing the data processing system to:
receive a second new function representation that is omitted from the set of user-invocable function representations, wherein the second new function representation is defined visually; and
store the second new function representation in the set of user-invocable function representations so that the second new function representation may be accessed from the user interface.

6. A method of visual programming in an environment having a set of user-invocable function representations, comprising:
maintaining a user interface from which a user may access any function representation in the set of user-invocable function representations;
receiving a new function representation that is omitted from the set of user-invocable function representations; and
storing the new function representation in the set of user-invocable function representations so that the new function representation may be accessed from the user interface.

7. A method of visual programming as claimed in claim 6, wherein the new function representation is defined declaratively.

8. A method of visual programming as claimed in claim 6, wherein the new function representation is defined visually.

9. A method of visual programming as claimed in claim 6, wherein the new function representation is a call to a primitive function in an imperative programming language.

10. A method of visual programming as claimed in claim 9, wherein the new function representation is a first new function representation and wherein the method further comprises:
receiving a second new function representation that is omitted from the set of user-invocable function representations, wherein the second new function representation is defined visually; and
storing the second new function representation in the set of user-invocable function representations so that the second new function representation may be accessed from the user interface.

11. A computer program product comprising at least one computer usable medium including computer-usable program code for providing a visual editor, said computer program product including:
computer-usable program code for a set of user-invocable function representations;
computer-usable program code for maintaining a user interface from which a user may access any function representation in the set of user-invocable function representations;
computer-usable program code for receiving function definition input from a user, for defining a new function representation that is omitted from the set of user-invocable function representations; and
computer-usable program code for storing the new function representation in the set of user-invocable function representations so that the new function representation may be accessed from the user interface.

12. A computer program product as claimed in claim 11, wherein the computer-usable program code for receiving function definition input includes computer-usable program code for an interface for receiving declarative function definition input.

13. A computer program product as claimed in claim 11, wherein the computer-usable program code for receiving function definition input includes computer-usable program code for an interface for receiving visually defined function definition input.

14. A computer program product as claimed in claim 11, wherein the computer-usable program code for receiving function definition input includes computer-usable program code for an interface for receiving visually defined function definition input that includes a call to a primitive function that exists in an imperative programming language.

15. A computer program product as claimed in claim 14, wherein the computer-usable program code for receiving function definition input further includes computer-usable program code for an interface for receiving visually defined function definition input.
